(19) United States
(12) Patent Application Publication
(10) Pub. No.: US 2011/0228326 A1
(43) Pub. Date: Sep. 22, 2011

(54) SETTING SYSTEM, SETTING METHOD, AND SETTING SUPPORTING APPARATUS FOR IMAGE PROCESSING APPARATUS

(75) Inventors: Naoki Hoshino, Saitama-ken (JP); Yuko Kimoto, Tokyo (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/044,733

(22) Filed: Mar. 10, 2011

Related U.S. Application Data
(60) Provisional application No. 61/314,663, filed on Mar. 17, 2010.
(60) Provisional application No. 61/314,660, filed on Mar. 17, 2010.
(60) Provisional application No. 61/314,669, filed on Mar. 17, 2010.

(51) Int. Cl. G06F 3/12

(52) U.S. Cl. 358/1.15

(57) ABSTRACT

According to one embodiment, a setting system includes an image processing apparatus and a computer. The setting system includes a setting-information transmitting unit, an image display unit, an updated-information transmitting unit, and an updating unit. The setting-information transmitting unit transmits setting information stored in a storing unit of the image processing apparatus. The image display unit displays setting information on a display unit of the computer as an image same as an image displayed by a display unit included in the image processing apparatus. The updated-information transmitting unit transmits updated information updated by the computer with respect to the setting information. The updating unit updates the setting information with the transmitted updated information.

### CROSS-REFERENCE TO RELATED APPLICATIONS

This application is based upon and claims the benefit of priority from: U.S. provisional application 61/314,663, filed on May 17, 2010; U.S. provisional application 61/314,660, filed on May 17, 2010; and U.S. provisional application 61/314,669, filed on May 17, 2010; the entire contents all of which are incorporated herein by reference.

### FIELD

Embodiments described herein relate generally to a technique for setting in an image processing apparatus.

### BACKGROUND

Data obtained by compiling, for example, distinction of monochrome printing and color printing, sheet sizes, magnifications, and distinction of duplex printing and simplex printing (hereinafter referred to as template) is stored in an image processing apparatus. The image processing apparatus controls copying, scanning, and facsimile transmission according to this template. As the template, there are an individual template separately set for each user and a shared template applied to all users who use the image processing apparatus and users belonging to a predetermined group.

In the past, there is a system in which the template can be set on a PC (Personal computer) used by a user. However, in a certain system, for example, in a template for performing copying, only items in an outer frame of the template such as user name in use and a template name can be set. Contents such as a sheet size and a magnification cannot be set in the PC. Therefore, in this system, a user goes to a setting place of an image processing apparatus and sets contents using a control panel included in the image processing apparatus. This work is a burden for the user. Since the user exclusively uses a control panel, the user prevents operation of the image processing apparatus by other users during the work.

On the other hand, in another system in the past, a user can create and update setting contents in a PC used by the user. However, while the user is performing setting work for a template on the PC, the system does not accept setting work in other PCs and control panels. As explained above, while one user performs setting work, the user prevents setting work for an image processing apparatus by other users.

### BRIEF DESCRIPTION OF THE DRAWINGS

FIG. 1 is a schematic diagram of the configuration of a setting system for an image processing apparatus;

FIG. 2 is a diagram of an example of functional blocks of a personal computer and an image processing apparatus;

FIG. 3 is a flowchart for explaining an example of the operation of the setting system;

FIG. 4A is a diagram of an example of display of a list of setting information (addresses), which is to be transmitted, by an image display unit;

FIG. 4B is a diagram of an example of display of setting information (an address), which is input by a user, by the image display unit;

FIG. 5A is a diagram of an example of display of updated setting information (an updated address) by the image display unit;

FIG. 5B is a diagram of a display example of the image display unit in which an image is displayed in arrangement same as that in display on a control panel;

FIG. 6 is another example of display of setting information (addresses) by the image display unit;

FIG. 7A is a diagram of an example of display of setting information (a template for copying), which is to be transmitted, by the image display unit;

FIG. 7B is a diagram of a display example of the image display unit during input work for setting values by a user;

FIG. 8 is a diagram of another display example of the image display unit during the input work for setting values by the user;

FIG. 9A is a diagram of a display example (list display) of the image display unit after completion of registration of the template for copying; and

FIG. 9B is a diagram of a display example of the image display unit in which an image is displayed in arrangement same as that in display on the control panel.

### DETAILED DESCRIPTION

In general, according to one embodiment, a setting system for an image processing apparatus includes the image processing apparatus and at least one computer. The setting system includes a setting-information transmitting unit, an image display unit, an updated-information transmitting unit, and an updating unit. The setting-information transmitting unit transmits setting information stored in a storing unit of the image processing apparatus. The image display unit displays setting information, which is to be transmitted by the setting-information transmitting unit, on a display unit of the computer as an image same as an image displayed by a display unit included in the image processing apparatus. The updated-information transmitting unit transmits updated information updated by the computer with respect to the setting information displayed by the image display unit. The updating unit updates the setting information stored in the storing unit of the image processing apparatus with the updated information transmitted by the updated-information transmitting unit.

In the following explanation, it is assumed that WEB browser software is installed in a PC in advance and control of display is performed by the WEB browser. Server software for transmitting data to at least a PC of a WEB server or the like is implemented in an image processing apparatus. The image processing apparatus outputs current setting contents of the image processing apparatus to the PC in response to a request of the PC. As an example of the implementation, implementation on a JAVA (registered trademark) basis, Javascript (registered trademark), or an HTML language is used. The WEB browser analyzes a code and performs display control. However, these implementations do not limit a form. Other techniques may be adopted as a method of display control and a language in use.

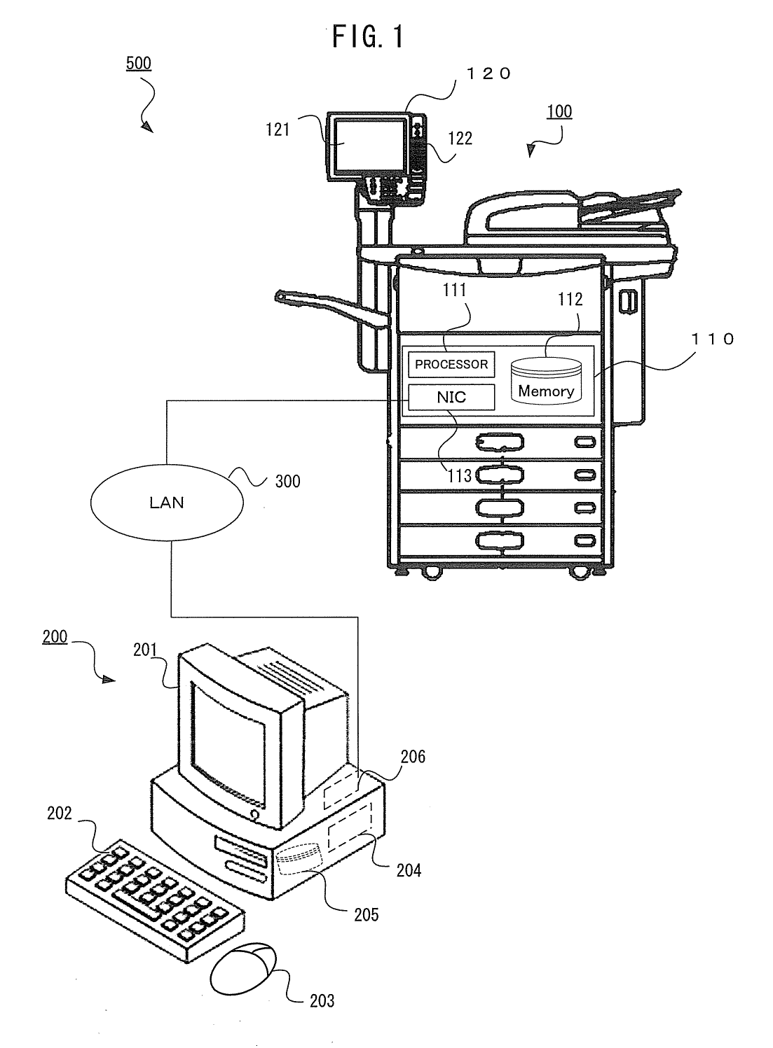

A setting system according to an embodiment is explained below with reference to the accompanying drawings. First, the configuration of the setting system according to this embodiment is shown in FIG. 1. A setting system 500 includes an image processing apparatus 100, which is a MFP (Multifunction Peripheral), having a copying function, a printer function, a scanner function, and a function of transmitting and receiving facsimiles and emails and a PC 200 used by a user. The image processing apparatus 100 and the PC 200 are connected by a LAN 300 and are capable of communicating with each other.

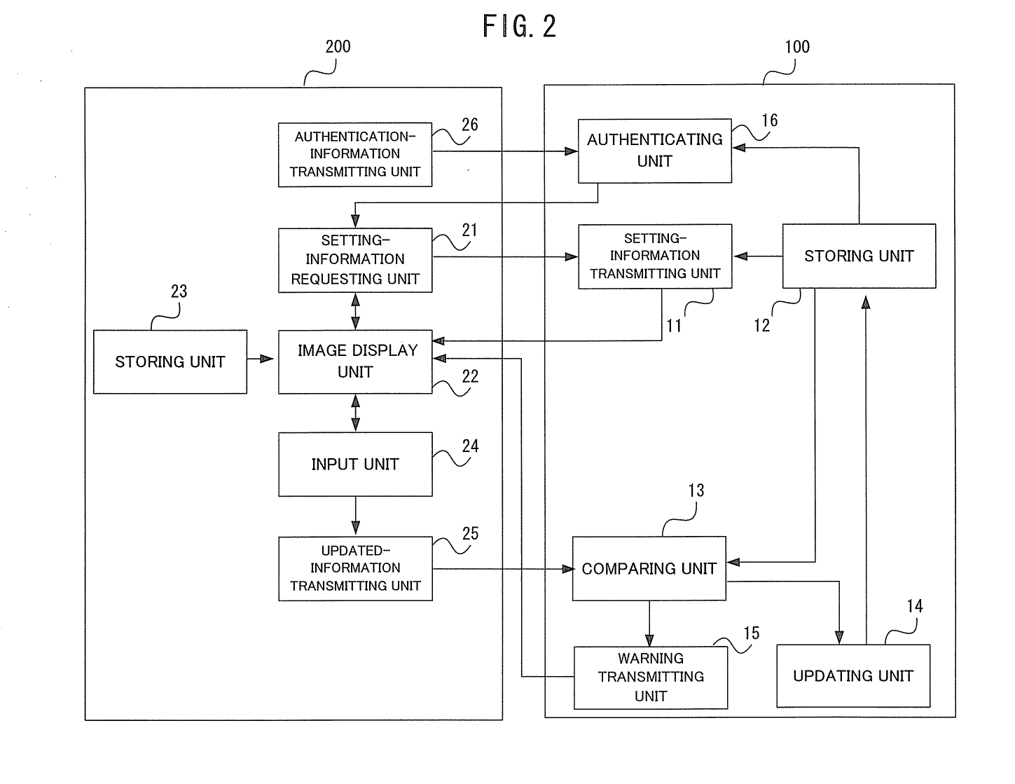

The image processing apparatus 100 includes a control board 110 configured to collectively control hardware devices in the apparatus and realize units explained with reference to FIG. 2 and subsequent figures. The control board 110 includes a processor 111, which is an arithmetic processing device, and a memory 112 including a RAM (Random Access Memory), which is a volatile storage device, and a ROM (Read Only Memory) and a HDD (Hard disk drive), which are nonvolatile storage devices. The control board 110 includes a NIC (Network Interface Card) 113 configured to control communication with the outside. The image processing apparatus 100 includes a control panel 120 including a keyboard 122 configured to receive an instruction from the user and a touch panel display 121 configured to display control contents and receive an instruction from the user.

A hardware configuration of the PC 200 is the same as that of the existing PC. The PC 200 includes a processor 204, a memory 205, a NIC 206, a keyboard 202 and a mouse 203 configured to receive an input from the user, and a monitor 201 configured to display an image to the user. The NIC 113 and the NIC 206 perform control of communication with each other via the LAN 300.

Functional blocks of the apparatuses are explained below with reference to FIG. 2. The PC 200 includes a setting-information requesting unit 21, an image display unit 22, a storing unit 23, an input unit 24, and an updated-information transmitting unit 25. The units of the PC 200 shown in FIG. 2 are realized by a configuration including the processor 204 and the memory 205 (referred to as configuration A). The units are realized by a computer program stored in the memory 205 in advance being executed by the processor 204. The setting-information requesting unit 21 and the updated-information transmitting unit 25 are realized by, in addition to the configuration A, a configuration including the NIC 206. The image display unit 22 is realized by, in addition to the configuration A, a configuration including the monitor 201 and the NIC 206. The input unit 24 is realized by, in addition to the configuration A, a configuration including the keyboard 202 and the mouse 203.

The image processing apparatus 100 includes a setting-information transmitting unit 11, a storing unit 12, a comparing unit 13, an updating unit 14, and a warning transmitting unit 15. The units of the image processing apparatus 100 shown in FIG. 2 are realized by a configuration including the processor 111 and the memory 112 (referred to as configuration B). The units are realized by a computer program stored in the memory 112 in advance being executed by the processor 111. The setting-information transmitting unit 11, the comparing unit 13, and the warning transmitting unit 15 are realized by, in addition to the configuration B, a configuration including the NIC 113.

As an auxiliary configuration in this embodiment, the PC 200 includes an authentication-information transmitting unit 26 configured to acquire, using the keyboard 202, identification information and a password of the user who performs setting and transmit the identification information and the password to the image processing apparatus 100. The image processing apparatus 100 includes an authenticating unit configured to determine whether the identification information and the password of the user transmitted to the image processing apparatus 100 are identification information and a password registered in the storing unit 12 in advance.

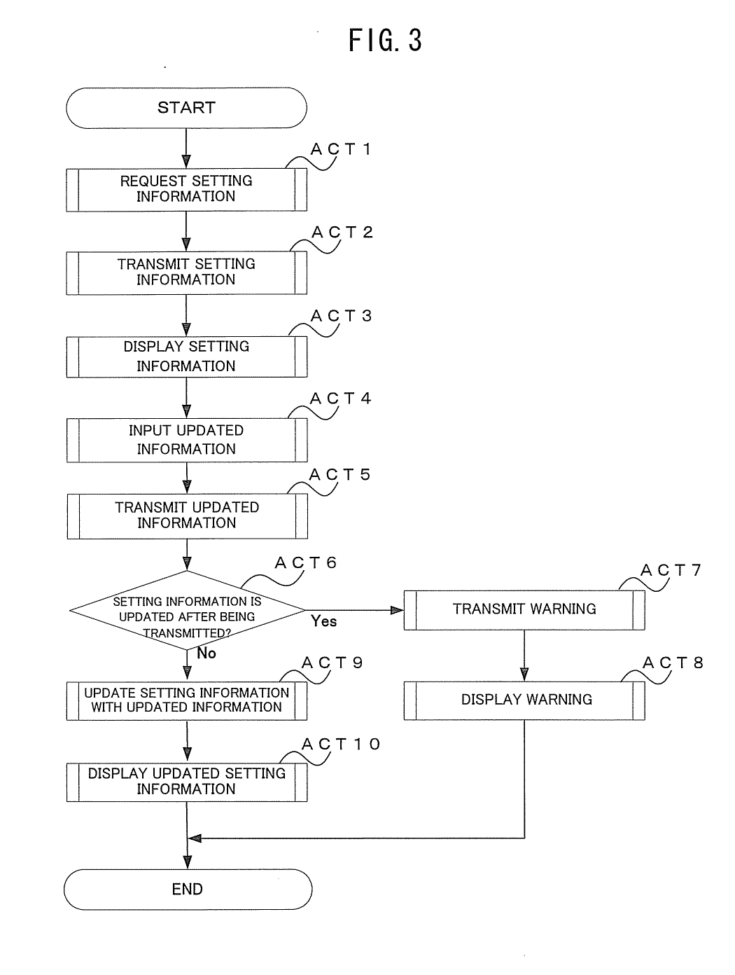

The operation of the setting system 500 is explained with reference to a flowchart of FIG. 3. In the following explanation, the user registers a facsimile number and an email address of an acquaintance in the image processing apparatus 100 using the PC 200. The flowchart of FIG. 3 is a flowchart of operation performed after authentication processing for the user by the authentication-information transmitting unit 26 and the authenticating unit 16 is completed.

The setting-information requesting unit 21 of the PC 200 transmits, according to predetermined operation by the user, a telegraphic message for requesting address information (setting information) already registered in the image processing apparatus 100 such as a facsimile number and an email address to the image processing apparatus 100 (ACT 1).

The setting-information transmitting unit 11 of the image processing apparatus 100 receives the request telegraphic message, acquires setting information stored in the storing unit 12, and transmits the setting information to the PC 200 (ACT 2). In ACT 2, the setting-information transmitting unit 11 temporarily stores the transmitted setting information currently stored in the storing unit 12 in another storage area in the memory 112.

The image display unit 22 of the PC 200 receives the setting information transmitted from the setting-information transmitting unit 11, acquires forms for display (image data including an HTML file, a Javascript file, and an icon) stored in the storing unit 23 in advance and displays the current setting information to the user (ACT 3). Implementation is also possible in which the forms for display is stored in the storing unit 12 of the image processing apparatus 100 and the setting-information transmitting unit 11 transmits data for display to the image display unit 22 (the same applies below).

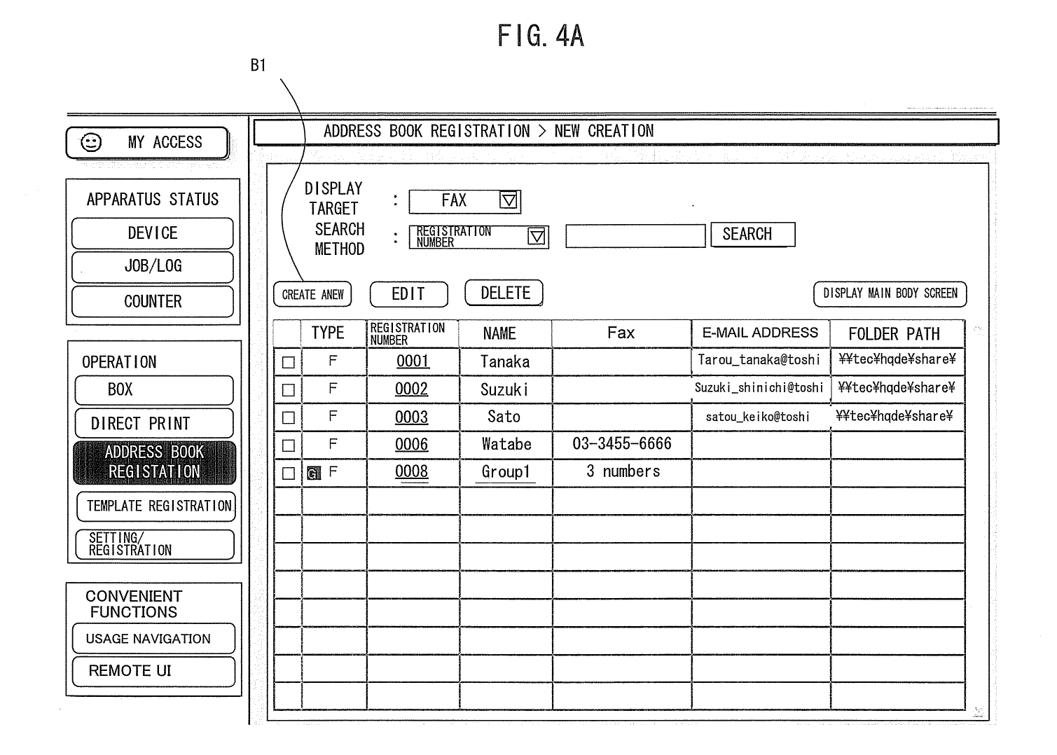

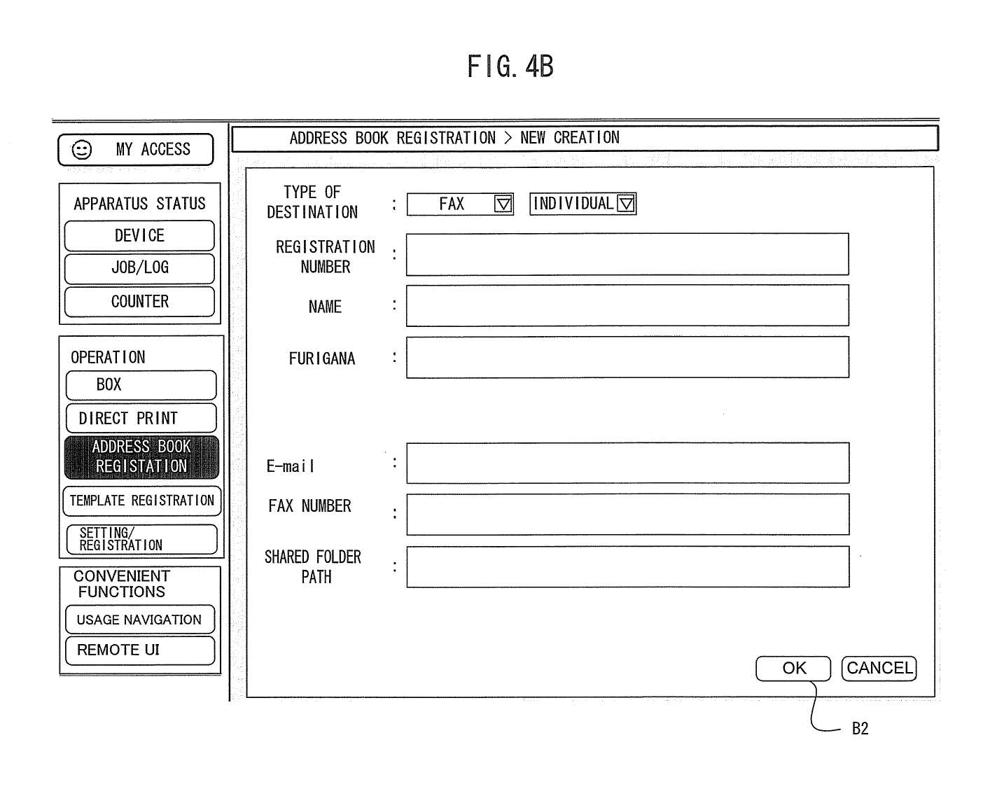

An example of the display by the image display unit 22 in ACT 3 is shown in FIG. 4A. The image display unit 22 displays, for each of registration numbers already registered, setting information of a name, a facsimile number, an email address, and a folder path, in which data is stored, on the monitor 201 as a list. Values of the setting information displayed on the image display unit 22 are stored in association with one another in at least the storing unit 12 (the same applies below).

When a button B1 (a “create anew” button) on the display of the input unit 24 is pressed on the basis of operation by the user, the image display unit 22 acquires a form for new creation from the storing unit 23 and displays an input form shown in FIG. 4B.

The input unit 24 inputs data to a predetermined space of the input form according to operation by the user (ACT 4). When a button B2 (an “OK” button) is pressed, the updated-information transmitting unit 25 transmits input information (updated information) to the image processing apparatus 100 (ACT 5).

The comparing unit 13 of the image processing apparatus 100, which acquires the updated information, compares the setting information currently stored in the storing unit 12 and the setting information temporarily stored in ACT 2 to determine whether the setting information is updated via the control panel 120 or another PC in a period from the transmission of the setting information in ACT 2 until the reception of the updated information (ACT 6).

If the comparing unit 13 determines that the setting information is updated (Yes in ACT 6), the warning transmitting unit 15 transmits a warning telegraphic message to the PC 200 (ACT 7). The image display unit 22 of the PC 200 displays a warning on the monitor 201 (ACT 8). The user checks the warning, determines whether the data is updated with the updated information transmitted in ACT 4, and performs operation corresponding to the determination.

On the other hand, if the comparing unit 13 determines that the setting information is not updated (No in ACT 6), the updating unit 14 updates the setting information stored in the storing unit 12 with the updated information transmitted in ACT 5 (ACT 9). Thereafter, the setting-information transmitting unit 11 acquires, as in ACT 2, the updated setting information from the storing unit 12 and transmits the updated setting information to the PC 200. The image display unit 22 of the PC 200 displays, as in Act 3, the updated setting information (ACT 10).

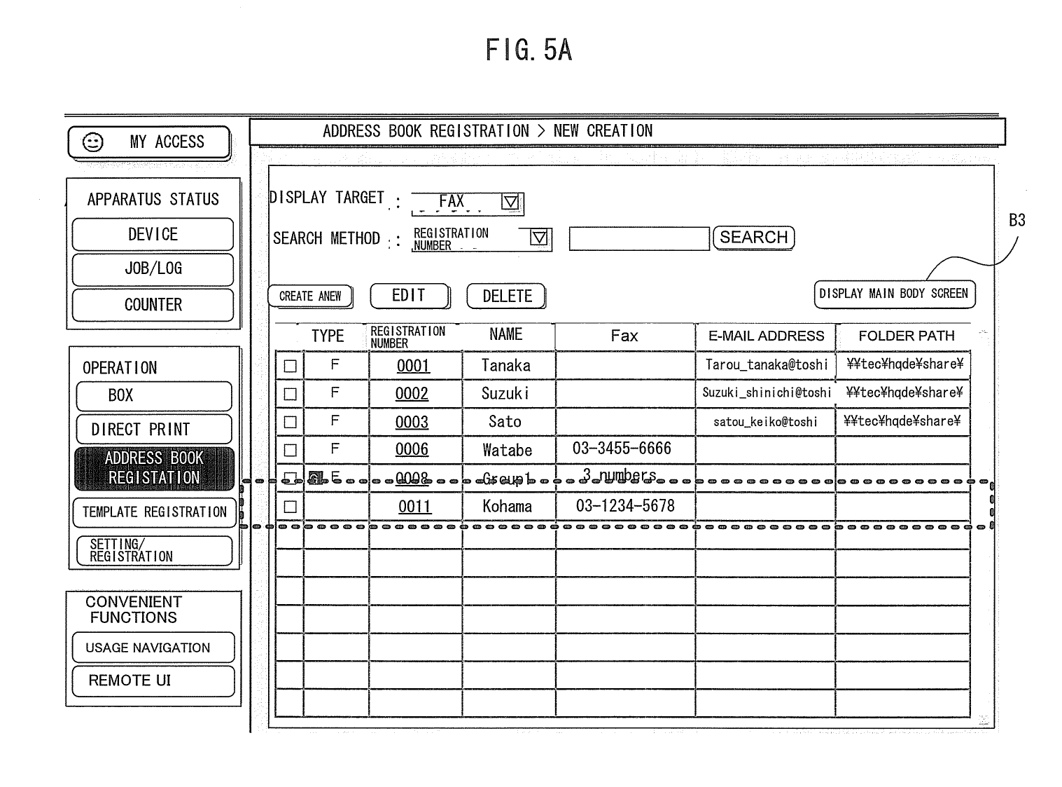

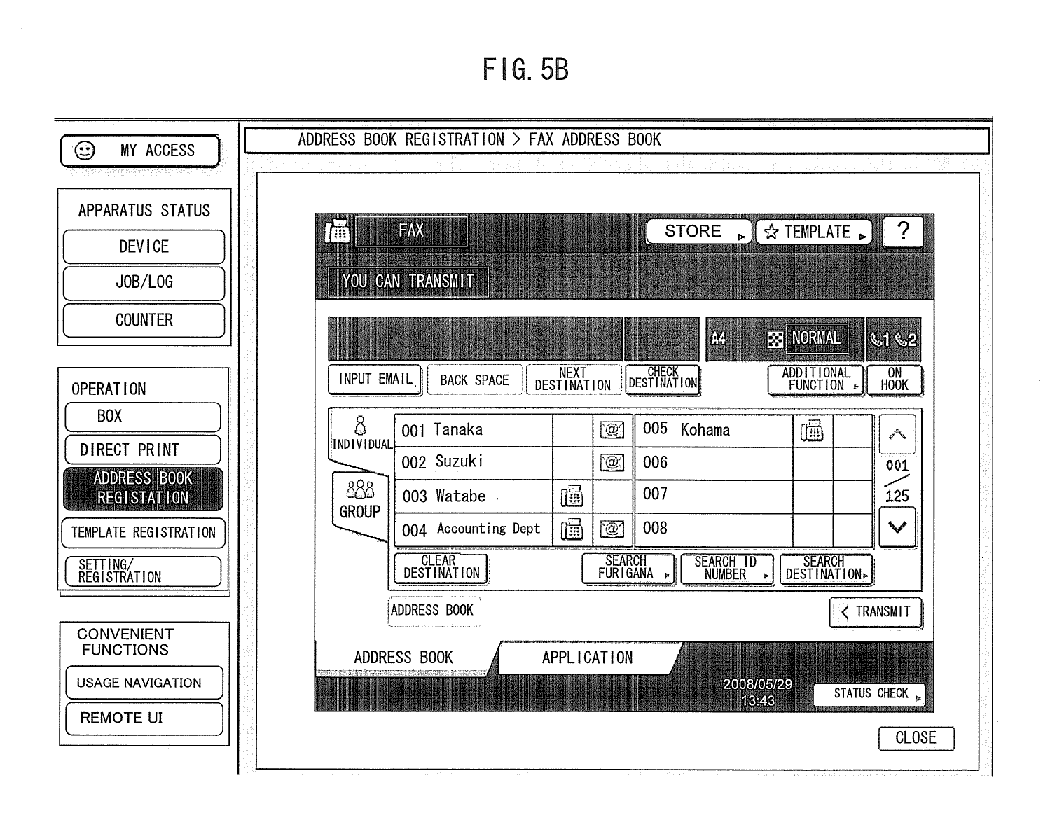

A display example by the image display unit 22 in ACT 10 is shown in FIG. 5A. According to the processing explained above, the user can check that an address surrounded by a broken line is registered.

If a button B3 (a “display main body screen” button) of the input unit 24 is pressed on the basis of operation by the user, the image display unit 22 acquires form data such as image data from the storing unit 23 and arranges and displays the image data and the setting information (in this example, text data) in a layout same as a layout of display of the control panel 120 of the image processing apparatus 100. A display example at the time when the button B3 is pressed is shown in FIG. 5B. Like an image shown in FIG. 5B, the image processing apparatus 100 causes the touch panel display 121 to display the registered setting information thereon as icon buttons and allows the user to press the icon buttons on the touch panel display 121. In this way, the image display unit 22 of the PC 200 displays contents same as contents displayed on the control panel 120 of the image processing apparatus 100. Consequently, the user can check with one click, from the PC 200 of the user, an updated layout state displayed on the control panel 120 of the image processing apparatus 100.

If the display on the control panel 120 and a setting check screen of the PC 200 are different, the user cannot determine in the PC 200 in the user's desk in which position on the control panel 120 an icon button is arranged. As in this embodiment, if the display on the control panel 120 and the display on the monitor 201 of the PC 200 are the same, the user can check how registration is completed on an interface without going to a setting place of the image processing apparatus 100.

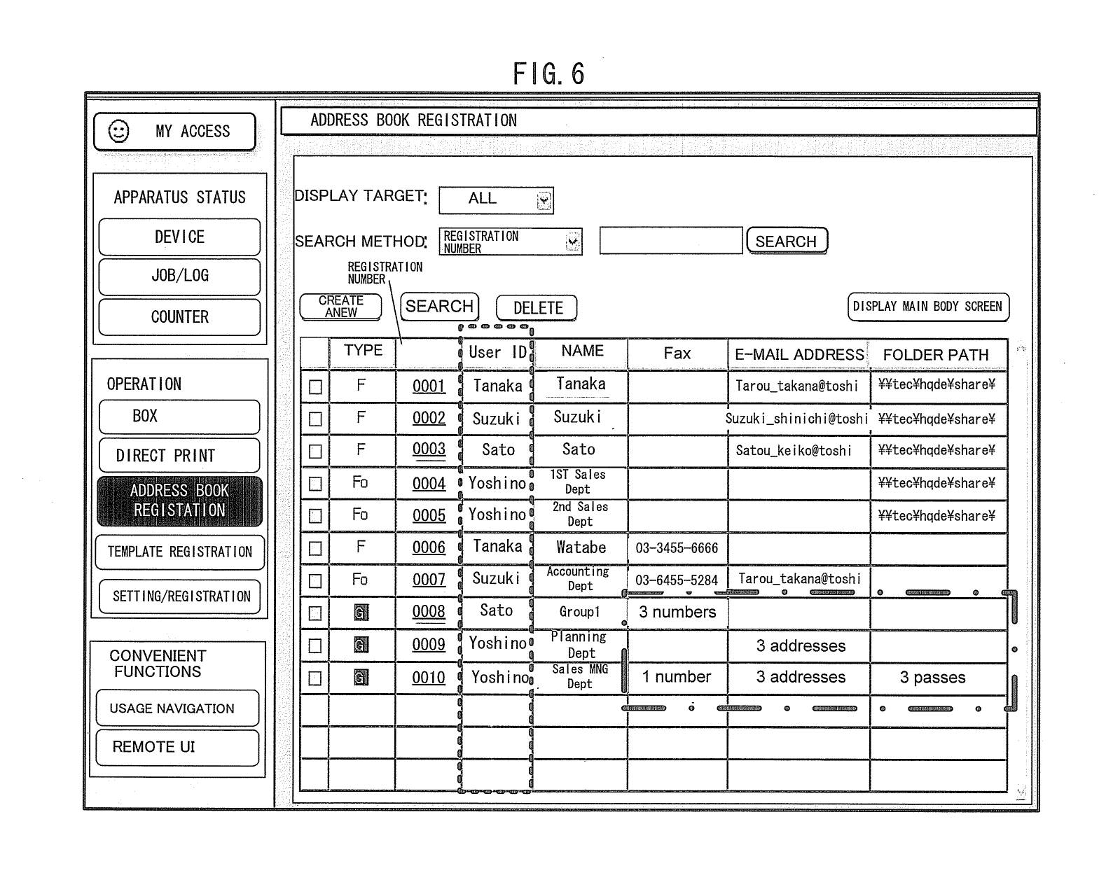

If setting information is registered in units of groups as shown in FIG. 6, the image display unit 22 totalizes and displays how many pieces of setting information are registered in the groups (see the inside of an alternate long and short dash line shown in FIG. 6). In this processing, the setting-information transmitting unit 11 acquires the setting information stored in the storing unit 12 and performs totalization for each of the groups (determination concerning whether the setting information is registered in units of groups is based on whether a “type” column of records stored in the storing unit 12 is a group type). Alternatively, the image di splay unit 22 that receives the setting information may perform the totalization. In this way, concerning the groups, since totalized values are displayed, a display form is different from display of addresses individually registered. Therefore, the user can easily check that group registration is performed. If all pieces of registered information are displayed as a list rather than the totalized values, since the display is complicated, the user requires time to search for an address. However, since the totalized values are displayed concerning the groups, search work for an address is facilitated.

As indicated by a broken line shown in FIG. 6, the image display unit 22 also displays names of users who perform registration work (identification information of the users, ‘User ID’) in the list in association with the registration information. This display is realized by acquiring the identification information of the users authenticated by the authenticating unit 16 from the storing unit 12 in association with the registration information. The registered user names are displayed in this way. Therefore, since an address can be searched using a registered user name, searchability is improved. Even if the authentication-information transmitting unit 26 and the authenticating unit 16 are not provided, i.e., the user authentication is not performed, if an updater name input space is provided on a form for updating setting information (e.g., the form shown in FIG. 4B) and updater name information is also transmitted when updated information is transmitted, display same as the display shown in FIG. 6 is realized.

In the example explained above, the user registers the information such as the facsimile number and the email address. As another example, an example in which a template for copying is created and contents of the template for copying are changed is explained.

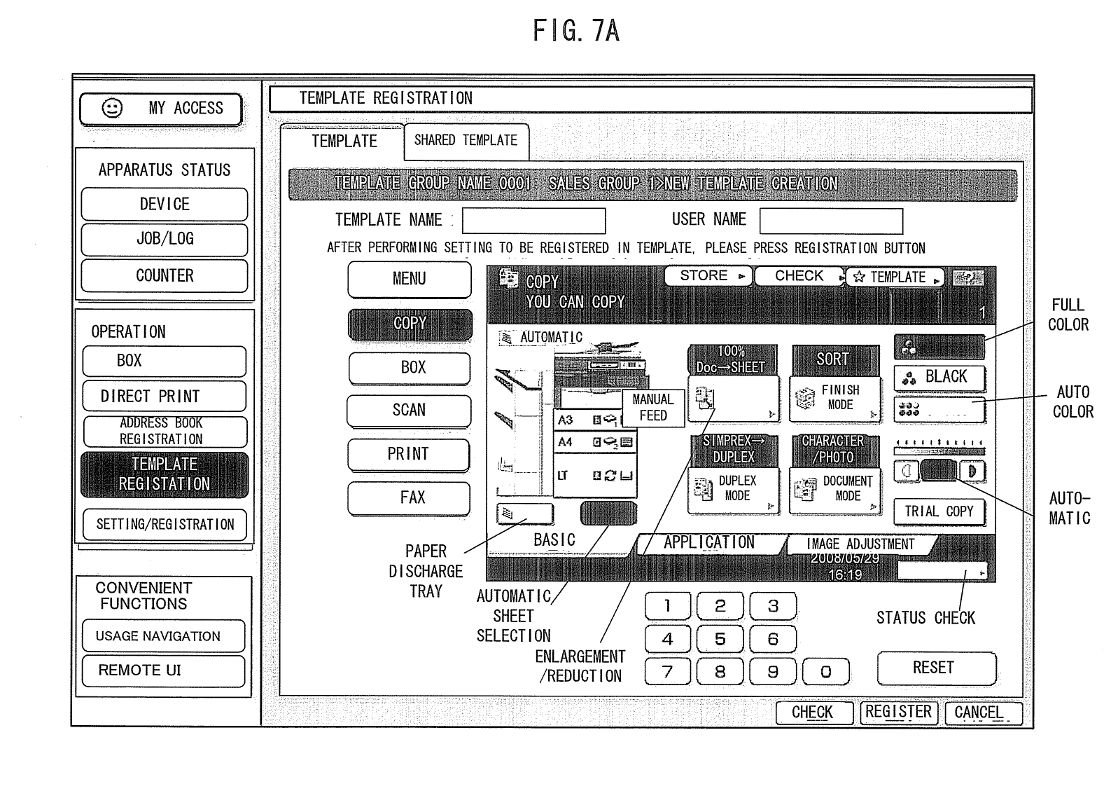

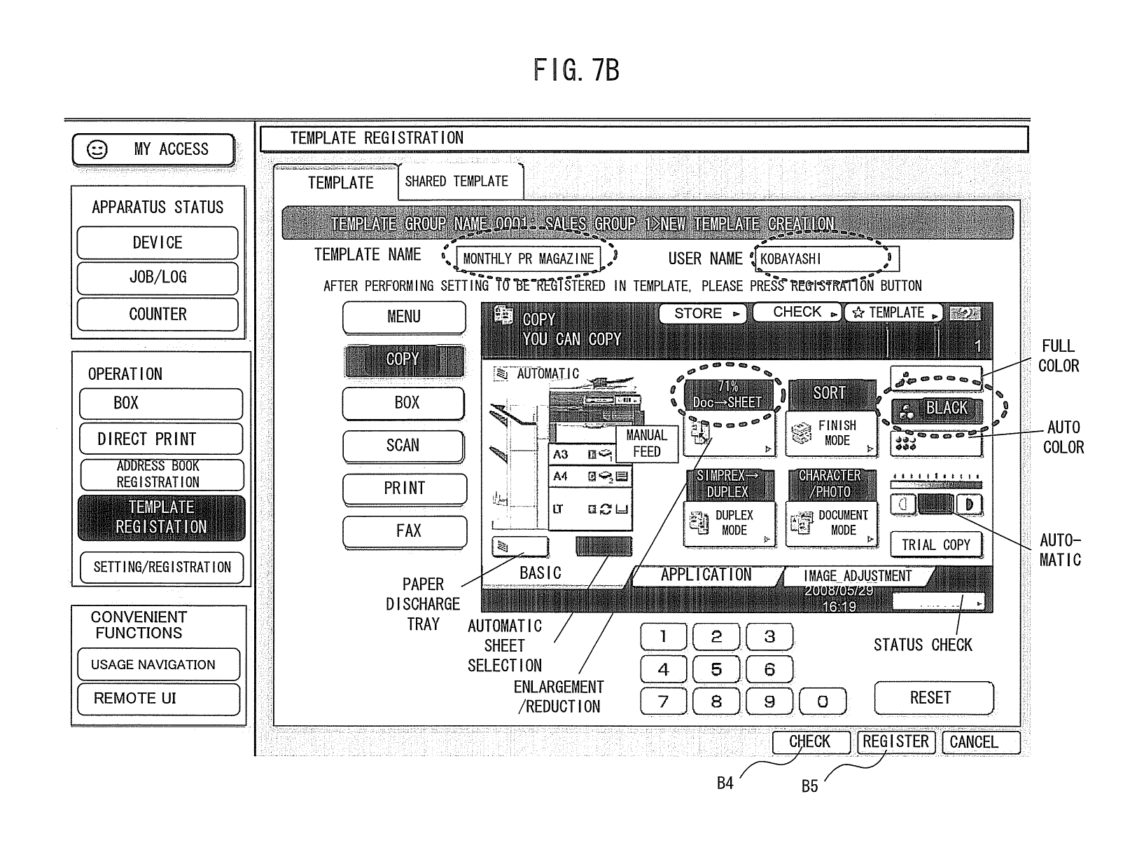

First, in FIG. 7A, a screen example displayed by the image display unit 22 after the setting-information transmitting unit 11 transmits setting information of a template for copying stored in the storing unit 12 to the PC 200 is shown (ACT 3 in the flowchart shown of FIG. 3). As explained above, the image display unit 22 acquires the received setting information, the display form stored in the storing unit 23, and the image data and shapes and displays an image to be displayed in the same manner as the display of the control panel 120 of the image processing apparatus 100.

The user specifies, using the input unit 24, sections necessary to be changed with respect to the setting information displayed on the image display unit 22 and changes values of the sections. A display example during this changing work is shown in FIG. 7B. Items surrounded by broken line frames in FIG. 7B are changed items. During this work by the user (work for determining values and inputting the determined values to the image display unit 22), since the work is performed only in the PC 200, the image processing apparatus 100 does not prevent setting work by other users, i.e., setting work from the control panel 120 and other PCs.

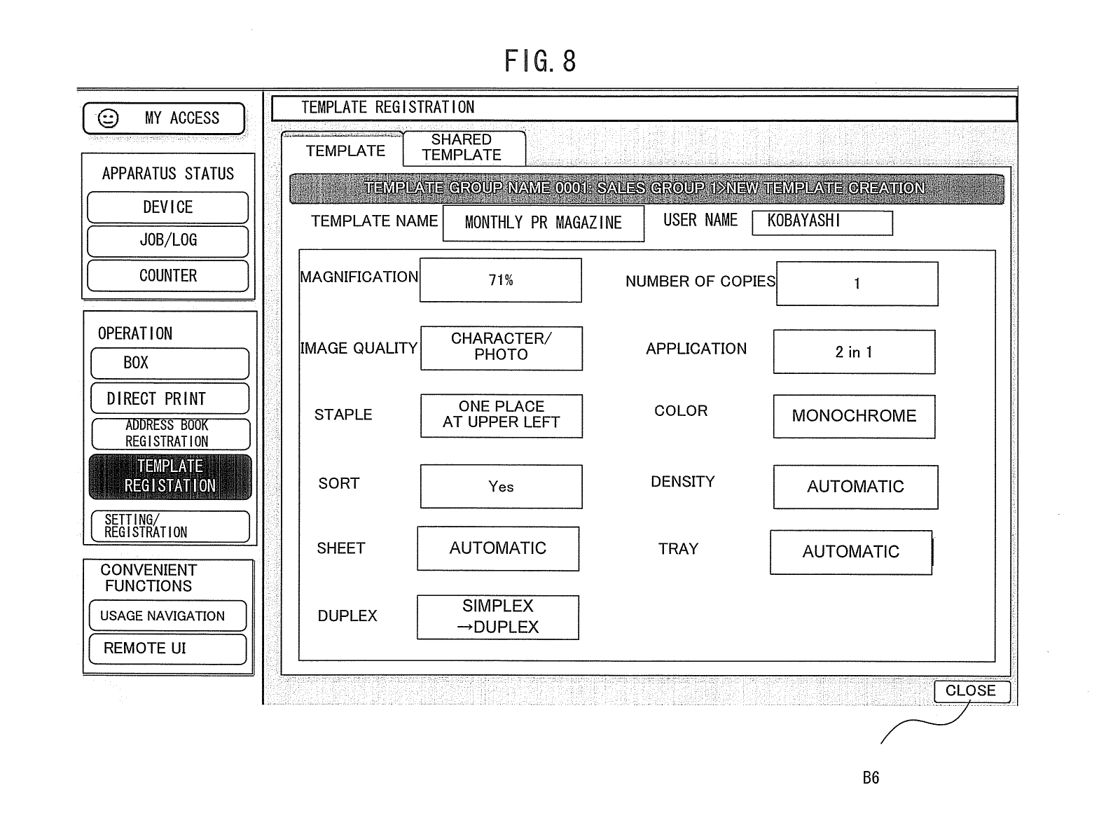

If a button B4 (a “check” button) is pressed by the user, the image display unit 22 switches the display to a form shown in FIG. 8. If a button B6 (a “close” button) of the form shown in FIG. 8 is pressed, the image display unit 22 performs control to return the form to the display shown in FIG. 7B. Implementation is also possible in which, if this switching processing is performed or a not-shown update button is pressed, the image display unit 22 displays, according to processing by the setting-information requesting unit 21 and the setting-information transmitting unit 11, latest setting information currently stored in the storing unit 12 in a space different from a space being set (the processing is the same as ACT 1 to ACT 3 shown in FIG. 3).

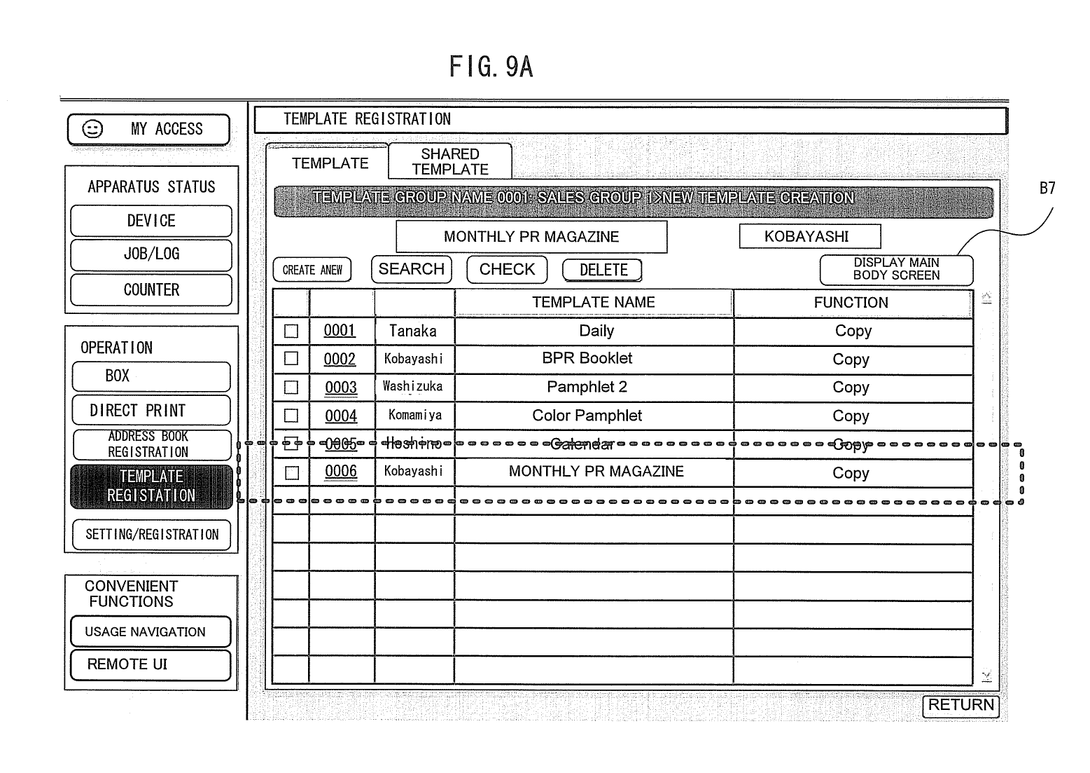

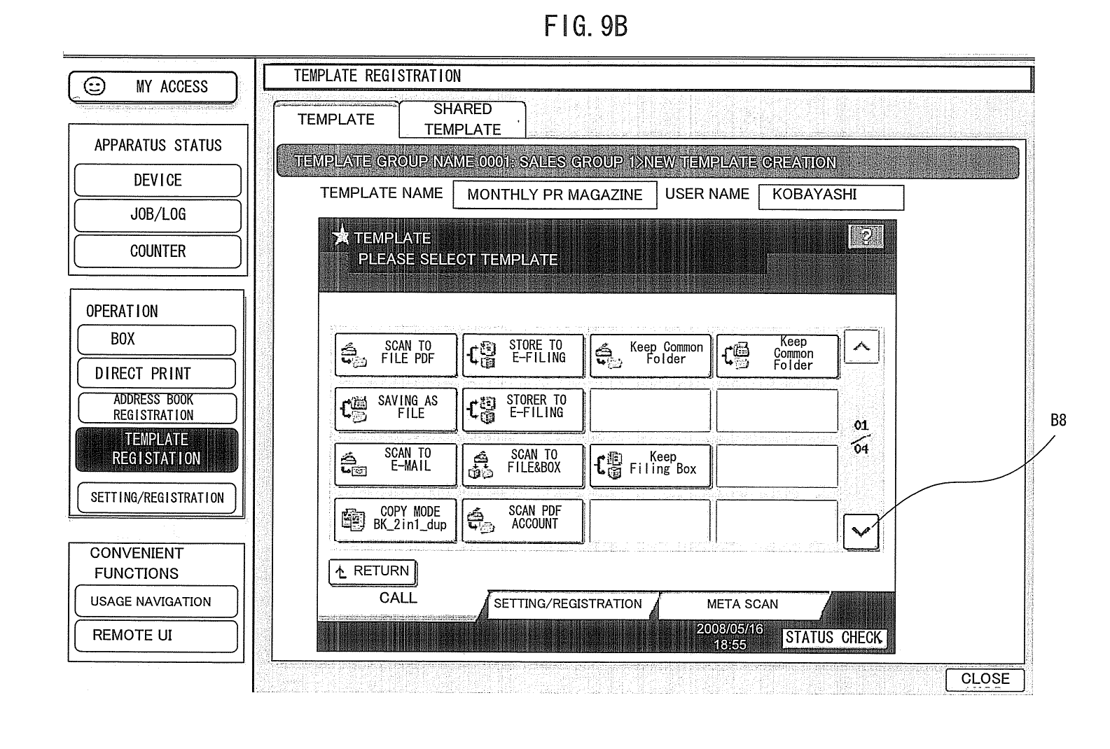

If the setting work performed by the user using the PC 200 ends and a button B5 (a “register” button) shown in FIG. 7B is pressed, the processing in ACT 5 to ACT 9 of the flowchart of FIG. 3 (if warning display is necessary, ACT 7 and ACT 8) is performed. In ACT 10, the image display unit 22 displays, for example, information updated as shown in FIG. 9A (information in a broken line frame shown in FIG. 9A is updated). If a button B7 (a “display main body screen” button) is pressed by the user, the image display unit 22 switches the display to a form shown in FIG. 9B. FIG. 9B is a diagram of an example, in which the image display unit 22 displays image data in a layout same as a layout displayed by the control panel 120 of the image processing apparatus 100. No display concerning the template for copying updated anew is present on FIG. 9B. However, if a page is switched by pressing a B8 button, the updated template for copying is displayed.

In the above explanation, the setting system 500 including the image processing apparatus 100 and the PC 200 is explained. However, this does not limit a form. The setting system 500 may be a system including plural image processing apparatuses and plural PCs. The setting system 500 may be a system including a management server, which is a computer including a processor and a memory. In this case, in the system, the management server takes charge of a part or all of processing performed by the authenticating unit 16, the setting-information transmitting unit 11, the comparing unit 13, the warning transmitting unit 15, and the updating unit 14.

It is also a form of this embodiment that the PC 200 is provided as a setting supporting apparatus for an image processing apparatus.

As explained above in detail, according to the technique described in this specification, when setting is performed on a PC, setting work by other users, i.e., setting work on a control panel of an image processing apparatus and other PCs is not prevented. Therefore, convenience is improved.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. A setting system for an image processing apparatus including the image processing apparatus and at least one computer, the setting system comprising:
a setting-information transmitting unit configured to transmit setting information stored in a storing unit of the image processing apparatus;
an image display unit configured to display setting information, which is to be transmitted by the setting-information transmitting unit, on a display unit of the computer as an image same as an image displayed by a display unit included in the image processing apparatus;
an updated-information transmitting unit configured to transmit updated information updated by the computer with respect to the setting information displayed by the image display unit; and
an updating unit configured to update the setting information stored in the storing unit of the image processing apparatus with the updated information transmitted by the updated-information transmitting unit.

2. The system according to claim 1, further comprising a comparing unit configured to determine whether the setting information is updated by another user in a period from the transmission of the setting information by the setting-information transmitting unit until reception of the updated information transmitted by the updated-information transmitting unit, wherein
the updating unit updates the setting information if the comparing unit determines that the setting information is not updated by the other user.

3. The system according to claim 2, further comprising a warning transmitting unit configured to transmit a warning telegraphic message if the comparing unit determines that the setting information is updated by the other user, wherein
the image display unit further acquires the warning telegraphic message transmitted by the warning transmitting unit and displays the warning telegraphic message on the display unit of the computer.

4. The system according to claim 1, wherein the setting information is template data for copying of the image processing apparatus.

5. The system according to claim 1, wherein the image display unit further displays the setting information as a list.

6. The system according to claim 5, wherein the image display unit further displays pieces of identification information of a registering person of the setting information in association with one another in spaces of the list.

7. The system according to claim 6, further comprising an authenticating unit configured to acquire at least identification information of a user and determines possibility of use by the user on the basis of the identification information, wherein
the identification information of the registering person is the identification information authenticated by the authenticating unit.

8. The system according to claim 5, wherein, if the setting information to be displayed is information collectively registered as a group and there are plural numbers of data corresponding to one display space, the image display unit displays a totalized value of the numbers in the display space of the list.

9. The system according to claim 5, wherein the image display unit switches, according to predetermined operation by a user, the display by the list and the display in the image same as the image displayed by the display unit included in the image processing apparatus.

10. The system according to claim 1, wherein the setting-information transmitting unit and the updating unit are included in the image processing apparatus.

11. A setting method for an image processing apparatus of a system including the image processing apparatus and at least one computer, the setting method comprising:
the image processing apparatus transmitting setting information stored in a storing unit of the image processing apparatus;
the computer displaying setting information to be transmitted on a display unit of the computer as an image same as an image displayed by a display unit included in the image processing apparatus;
the computer transmitting updated information updated by the computer with respect to the setting information displayed by the image display unit; and
the image processing apparatus updating the setting information stored in the storing unit of the image processing apparatus with the transmitted updated information.

12. The method according to claim 11, further comprising:
the image processing apparatus determining whether the setting information is updated by another user in a period from the transmission of the setting information until reception of the updated information; and
the image processing apparatus updating the setting information if the image processing apparatus determines that the setting information is not updated by the other user.

13. The method according to claim 12, further comprising:
the image processing apparatus transmitting a warning telegraphic message if the image processing apparatus determines that the setting information is updated by the other user; and
the computer further acquiring the transmitted warning telegraphic message and displaying the warning telegraphic message on the display unit.

14. The method according to claim 11, wherein the setting information is template data for copying of the image processing apparatus.

15. The method according to claim 11, further comprising the computer further displaying the setting information on the display unit as a list.

16. The method according to claim 15, further comprising the computer further displaying pieces of identification information of a registering person of the setting information in association with one another in spaces of the list.

17. The method according to claim 16, further comprising the image processing apparatus further acquiring at least identification information of a user and determining possibility of use by the user on the basis of the identification information, wherein
the identification information of the registering person is the identification information authenticated by the authenticating unit.

18. The method according to claim 15, further comprising the computer displaying, if the setting information to be displayed is information collectively registered as a group and there are plural numbers of data corresponding to one display space, the image display unit displays a totalized value of the numbers in the display space of the list.

19. The method according to claim 15, further comprising the computer switching, according to predetermined operation by a user, the display by the list and the display in the image same as the image displayed by the display unit included in the image processing apparatus.

20. A setting supporting apparatus for an image processing apparatus comprising:
an image display unit configured to acquire setting information stored in a storing unit of the image processing apparatus and display the setting information on a display unit included in the setting supporting apparatus as an image same as an image displayed by a display unit included in the image processing apparatus; and
an updated-information transmitting unit configured to transmit updated information updated by the setting supporting apparatus with respect to the setting information displayed by the image display unit to the image processing apparatus.
